(19) United States
(12) Patent Application Publication
(10) Pub. No.: US 2009/0064329 A1
(43) Pub. Date: Mar. 5, 2009

(54) Zero-hour quarantine of suspect electronic messages

(75) Inventors: Kenneth K. Okumura, Sunnyvale, CA (US); Adam S. Dawes, San Carlos, CA (US); Peter K. Lund, San Francisco, CA (US); Erik S. Chen, Belmont, CA (US); Dmitriy Y. Larin, San Jose, CA (US); Carl S. Gutekunst, Los Actos, CA (US); James Cunningham, Los Altos, CA (US); Scott M. Petry, Palo Alto, CA (US)

Correspondence Address: BAKER & MCKENZIE LLP;PATENT DEPARTMENT, 2001 ROSS AVENUE, SUITE 2300, DALLAS, TX, 75201, US

(73) Assignee: GOOGLE INC., Mountain View, CA (US)

(21) Appl. No.: 12/146,333

(22) Filed: Jun. 25, 2008

Related U.S. Application Data
(60) Provisional application No. 60/946,054, filed on Jun. 25, 2007.

(51) Int. Cl. G06F 21/00

(52) U.S. Cl. 726/22

(57) ABSTRACT

The zero-hour quarantine comprises a tool for flagging potentially harmful messages/files prior to having an anti-virus signature published for a particular virus. The suspect file is sent to the zero-hour quarantine and periodically scanned, giving time for creation of a signature file that would then detect the virus. An example method may include receiving and examining a message for attributes indicative of its undesirability, and assigning a threat score to the message. The method may comprise disposing of the message by comparing the threat score to first and second thresholds, and the message sent to a permanent quarantine if the threat score passes the first threshold. The message is sent to the zero-hour quarantine if the assigned threat score does not pass the second threshold but passes the second threshold, or is delivered to the recipient if the assigned threat score does not pass the first or second threshold.

### PRIORITY CLAIM

This disclosure claims priority to U.S. Provisional Patent application No. 60/946,054, filed Jun. 25, 2007, which is commonly owned with the present disclosure and incorporated herein in its entirety.

### TECHNICAL FIELD

Disclosed embodiments herein relate generally to the filtering of electronic messages transmitted across a computer network, and more particularly to systems and methods for filtering electronic messages suspected of containing zero-hour threats.

### BACKGROUND

A “zero-day” or “zero-hour” vulnerability can be defined as a new vulnerability for which no anti-spam or anti-virus protection (or other appropriate means of protection) yet exists. Nearly every newly discovered vulnerability starts off this way, and in most cases a patch is available before the general public is made aware of the vulnerability. Recently, however, a significant rise in attacks that take advantage of zero-hour vulnerabilities has occurred, leaving a user or system unable to defend against the attack since no patch is available. Accordingly, protection against zero-hour attacks is becoming increasing desirable.

Unfortunately, current zero-hour protection is limited to zero-hour detection, not zero-hour disposition, of suspect messages. In such conventional approaches, messages suspected of containing zero-hour threats are typically just blocked or quarantined based on a perceived zero-hour threat. However, because of the very nature of zero-hour threats, detection is not very certain, thus resulting in a larger number of false-positives when filtering messages. If detection parameters are scaled back in an effort to reduce the number of false-positives, then often too many actual threats pass through the filtering system. As a result, since the detection of messages suspected of zero-hour threats falls short of adequately protecting against zero-hour threats, addressing the disposition of such messages addresses the false-positive problem.

### SUMMARY

The zero-hour quarantine disclosed herein, also referred to as the “penalty box,” in its earliest form began as a tool for anti-virus companies to get some advanced heuristics capabilities that would allow flagging an infected file as being suspect prior to having an anti-virus signature published for a particular virus. The suspect file would then go into the zero-hour quarantine and be scanned at a later point in time, giving the anti-virus companies time to create and publish a signature file that would then catch the virus. Disclosed herein is a description of advanced heuristics and message detection techniques for handling the disposition of such messages suspected of containing zero-hour threats.

In one embodiment, a method of filtering electronic messages from a network comprising a sending server and a destination server is provided. In such an embodiment, the method comprises receiving an incoming electronic message from the sending server, examining the electronic message for attributes indicative of its desirability or undesirability to an intended recipient of the electronic message, and assigning a threat score to the electronic message based on the examination. In addition, the method may comprise, disposing of the message according to a comparison of the threat score to first and second thresholds, wherein the message is sent to a permanent quarantine if the assigned threat score passes the first threshold. Alternatively, the message is sent to a temporary quarantine if the assigned threat score does not pass the second threshold but passes the second threshold, or the message is delivered to an intended recipient if the assigned threat score does not pass the first or second threshold.

In another embodiment, a system for filtering electronic messages from a network comprising a sending server and a destination server is provided. In such an embodiment, the system comprises a message handler configured to receive an incoming electronic message from the sending server, and a message filtering process in the message handler. The message filtering process may be configured to examine the electronic message for attributes indicative of its desirability or undesirability to an intended recipient of the electronic message, and assign a threat score to the electronic message based on the examination. The system may also include a message disposition process in the message handler, where the disposition process is configured to compare the assigned threat score to first and second thresholds. In addition, based on the comparison, the disposition process sends the message to a permanent quarantine if the assigned threat score passes the first threshold. sends the message to a temporary quarantine if the assigned threat score does not pass the second threshold but passes the second threshold, or sends the message to an intended recipient if the assigned threat score does not pass the first or second threshold.

In yet another embodiment, another method of filtering electronic messages from a network comprising a sending server and a destination server is provided. In this embodiment, the method comprises receiving an incoming electronic message from the sending server, examining the electronic message for attributes indicative of its desirability or undesirability to an intended recipient of the electronic message, and assigning a threat score to the electronic message based on the examination. In addition, such a method may comprise sending the message to a permanent quarantine if the revised threat score passes the first threshold, sending the message to a temporary quarantine if the assigned threat score does not pass the second threshold but passes the second threshold, or delivering the message to an intended recipient if the assigned threat score does not pass the first or second threshold. Moreover, the method may comprise periodically reexamining the message, if sent to the temporary quarantine, for attributes indicative of its desirability or undesirability to the intended recipient of the message, and revising the threat score based on the reexamination. In such an embodiment, the method may then include sending the message to a permanent quarantine if the revised threat score passes the first threshold, keeping the message in the temporary quarantine if the revised threat score does not pass the second threshold but passes the first threshold, or delivering the message to the intended recipient if the revised threat score does not pass the first or second threshold.

In still a further embodiment, another variation of a system for filtering electronic messages from a network comprising a sending server and a destination server is provided. In such an embodiment, the system may comprise a message handler configured to receive an incoming electronic message from the sending server. Also, the system may include a message filtering process in the message handler and configured to examine the electronic message for attributes indicative of its desirability or undesirability to an intended recipient of the electronic message, and assign a threat score to the electronic message based on the examination. Further, the system may also include a message disposition process in the message handler and configured to compare the assigned threat score to first and second thresholds, and then to send the message to a permanent quarantine if the assigned threat score passes the first threshold, send the message to a temporary quarantine if the assigned threat score does not pass the second threshold but passes the second threshold, or send the message to an intended recipient if the assigned threat score does not pass the first or second threshold. In such an embodiment of the system, the message filtering process may be further configured to periodically reexamine the message, if sent to the temporary quarantine, for attributes indicative of its desirability or undesirability to the intended recipient of the message, and revise the threat score based on the reexamination. Additionally, the message disposition process may be further configured to send the message to a permanent quarantine if the revised threat score passes the first threshold, send the message to a temporary quarantine if the revised threat score does not pass the second threshold but passes the second threshold, or send the message to an intended recipient if the revised threat score does not pass the first or second threshold.

In another aspect, yet another embodiment of a method of filtering electronic messages from a network comprising a sending server and a destination server is provided. In such an embodiment, the method may comprise receiving an incoming electronic message containing an attachment from the sending server, examining the attachment for attributes indicative of its harmfulness to an intended recipient of the electronic message, and assigning a threat score to the electronic message or the attachment based on the examination. In addition, such a method may include sending the message and attachment to a permanent quarantine if the revised threat score passes the first threshold, to a temporary quarantine if the assigned threat score does not pass the second threshold but passes the second threshold, or to an intended recipient if the assigned threat score does not pass the first or second threshold. The method may further include periodically reexamining the attachment, if sent to the temporary quarantine, for attributes indicative of its harmfulness to the intended recipient of the message, and revising the threat score based on the reexamination. As used herein, “harmfulness” means is the probability that the message or something associated with the message may harm, such as by rendering inoperable, hindering operation, or deleting files or other items from, a system associated with an intended recipient of on incoming message. Such harmfulness may be determined on a graduated scale, such as a predetermined threshold, and may be influenced by user- or administrator-based settings. Based on the revised threat score, the method may include sending the message and attachment to a permanent quarantine if the revised threat score passes the first threshold, keeping the message and attachment in the temporary quarantine if the revised threat score does not pass the second threshold but passes the first threshold, or delivering the message and attachment to the intended recipient if the revised threat score does not pass the first or second threshold.

In still another aspect, another embodiment of a system for filtering electronic messages from a network comprising a sending server and a destination server is provided. In such an embodiment, the system may include a message handler configured to receive an incoming electronic message containing an attachment from the sending server. Also, the system may include a message filtering process in the message handler and configured to examine the attachment for attributes indicative of its harmfulness to an intended recipient of the electronic message, and assign a threat score to the electronic message or the attachment based on the examination. In addition, such a system may include a message disposition process in the message handler and configured to compare the assigned threat score to first and second thresholds, and then to send the message and attachment to a permanent quarantine if the assigned threat score passes the first threshold, to a temporary quarantine if the assigned threat score does not pass the second threshold but passes the second threshold, or to an intended recipient if the assigned threat score does not pass the first or second threshold. Furthermore, the message filtering process may be further configured to periodically reexamine the attachment, if sent to the temporary quarantine, for attributes indicative of its harmfulness to the intended recipient of the message, and revise the threat score based on the reexamination. Additionally, the message disposition process may be further configured to send the message and attachment to a permanent quarantine if the revised threat score passes the first threshold, to a temporary quarantine if the revised threat score does not pass the second threshold but passes the second threshold, or to an intended recipient if the revised threat score does not pass the first or second threshold.

### BRIEF DESCRIPTION OF THE DRAWINGS

FIG. 1A illustrates a high-level block diagram of a message filtering system employing a system for handling zero-hour threats in accordance with the disclosed principles;

FIG. 1B illustrates a more detailed block diagram of a zero-hour threat message filtering system that is integrated with the message filtering system shown in FIG. 1A;

FIG. 2 illustrates a process flow for filtering incoming electronic messages in accordance with the disclosed principles; and

FIG. 3 illustrates a process flow for handling of messages already suspected of containing zero-hour threats.

### DETAILED DESCRIPTION

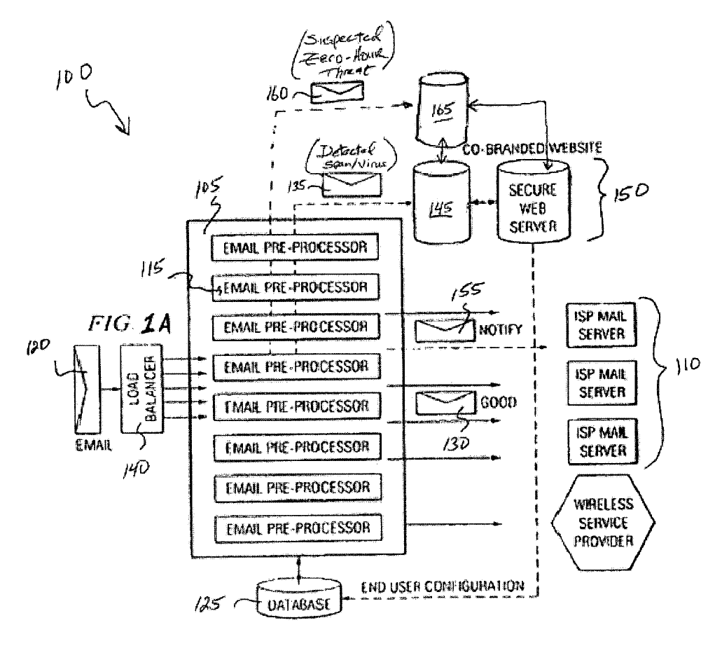

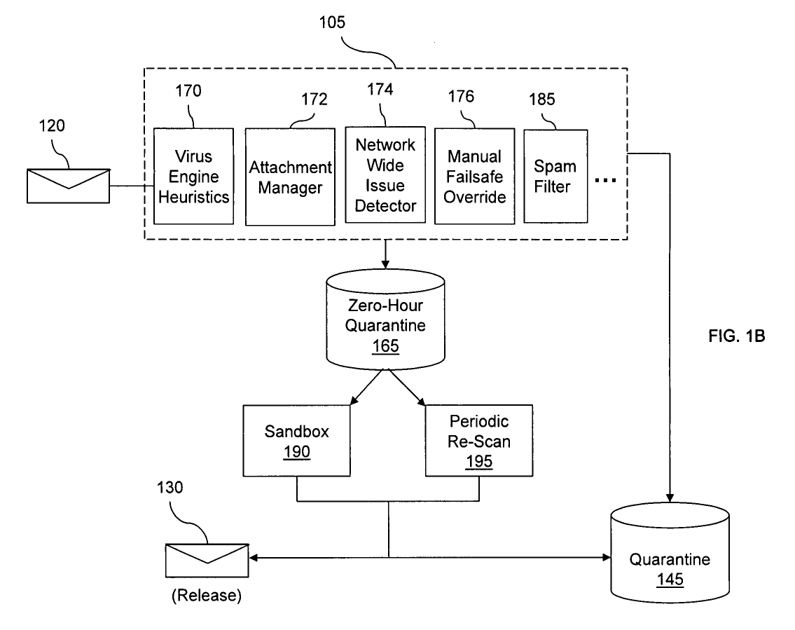

FIG. 1A illustrates a high-level block diagram of a message filtering system 100 employing an intermediate pre-processing service 105 along with a system for handling zero-hour threats in accordance with the disclosed principles. The intermediate pre-processing service 105 may be of the type disclosed in U.S. Pat. No. 6,650,890, which is commonly assigned with the present disclosure and incorporated herein in its entirety. Multiple hosts are defined on both the inbound mail server and the outbound mail server. Each host runs a copy of an appropriate mail program. In one embodiment, a machine or a cluster of machines 115 operates as a mail-receiving machine and a mail-delivering machine. This machine will accept a connection from a sending SMTP server and begin receiving data. Simultaneously, the machine will begin receiving the message data from incoming messages 120, querying a database 125 for a specific user configuration, processing messages 120 based on a configuration, opening a connection to a receiving SMTP server 110, and delivering a good message 130 or disposing of a suspect message 135.

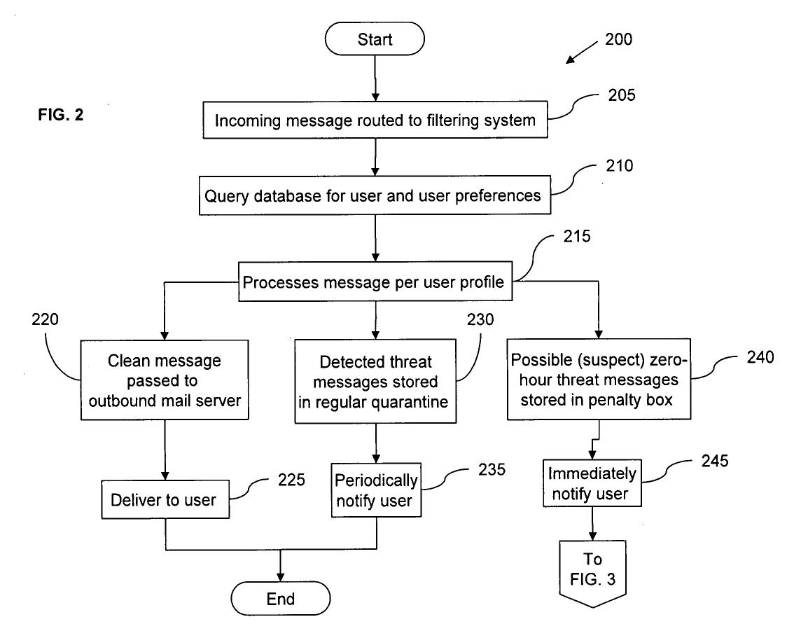

FIG. 2 illustrates a flow diagram showing a process flow for conducting zero-hour threat filtering of incoming electronic message in accordance with the disclosed principles. The following discusses the process flow 200 in FIG. 2 viewed in conjunction with FIG. 1A and FIG. 1B. FIG. 1B illustrates a more detailed block diagram of a zero-hour threat message filtering system that may be integrated with the message filtering system 100 shown in FIG. 1A.

Turning briefly back to FIG. 1, incoming mail 120 is first routed to an available host in the filtering system 105 by a load balancer 140 (or load-sharing switch/router), such as a type commonly available. This routing of the incoming messages is represented in Block 205 in FIG. 2. The server cluster 115 can include a server running a relational database management system such as Oracle®, for example. Of course, any type of relational database management system, or simply an arrangement of multiple servers, may also be employed with the disclosed systems and processes.

Once received in the server cluster 105, the host queries the database 125 to identify the user and user preferences of, for example, the intended recipient of the incoming message(s). The step is represented by Block 210 in the flow diagram of FIG. 2. After the specific user and his predetermined user preferences have been identified, the host then processes the message (s) 120 as specified in the identified user profile. This message processing is represented by Block 215 in FIG. 2.

Among the processing of the incoming messages, a number of various message processing software programs, add-ons, etc. may be available depending on the specific configuration of the system 100. For example, FIG. 1B illustrates virus engine heuristics 170, a manual failsafe override 176, a network-wide issue detector 174, an attachment manager 172, and a spam filter engine 185 for filtering the incoming messages 120. For spam checking, each host runs a copy of an appropriate spam filter, and for virus checking can be done using a virus scanning application such as that available from Trend). In addition, incoming message processing and SMTP connections may be processed using an active e-mail management system (EMS) such as the type disclosed in U.S. Pat. No. 6,941,348, which is also commonly assigned with the present disclosure and incorporated herein in its entirety.

Good/clean messages 130 are addressed with one or more addresses in accordance with information specified in the user profile, and sent to the outbound mail server cluster to be sent out to a receiving mail server 110 associated with the intended recipient of the good message 130. Such passing of the good messages 130 via outbound mail servers is represented by Block 220 in the diagram of FIG. 2. For example, to deliver a message addressed to “user@isp.com,” the intermediate preprocessing lookup service 105 could look up “user@postini-mail.isp.com” and deliver the message 130 to the appropriate receiving mail server 110 based on this look-up. This allows the Internet Service Provider (or enterprise server) to update the final delivery location without requiring the intermediate preprocessing service 105 to make any changes to the message 130. The good e-mail or other electronic message 130 is sent to the Internet Service Provider mail server 110 and possibly to other servers or gateways in accordance with the user profile. These good messages 130 then eventually routed to the appropriate intended recipient of the message 130. Such delivery to the intended user is illustrated as Block 225 in FIG. 2.

As discussed above, through the various available filters for incoming messages 120, bad e-mails 135 (e.g., determined to be spam or contain a virus, etc.) are detected. Instead of being delivered to the users, such bad messages 135 are saved in a “permanent” quarantine 145, as illustrated in FIG. 1B. When a bad message 135 is quarantined, a notification e-mail 155 is typically sent to the user; however, a periodic notification message 155 (e.g., once per day) may also be sent to the user. The diagram in FIG. 2 illustrates the sending of a notification message to the user in Block 235. This permanent quarantine 145 may also be accessible to users from a message center web site 150, where those users may choose to review the quarantined messages 135, and then have them delivered, deleted, or simply leave them there where they be deleted after the passage of time. Thus, the term “permanent quarantine” does not mean that messages sent there will never be removed from the quarantine, but instead as used herein this term means that the messages have been determined to be spam, harmful, or otherwise undesirable and therefore unwanted by the intended recipient in accordance to the criteria of the system, as well as the user's filtering preferences. This is contrasted from messages that have one or more attributes that might result in a message being harmful to the user or his system, or might result in the message being undesirable or unwanted by the intended recipient. The quarantining of the bad messages 135 is represented by Block 230 in FIG. 2, while the messages that might be harmful or unwanted, the zero-hour threat message, are discussed in detail below.

In one embodiment, the filtering of messages into the permanent quarantine 145 may be done using a graduated scale with a threshold. In such an embodiment, the filtering system 100 would examine an incoming message based on attributes indicative of its desirability or undesirability to an intended recipient of the electronic message, and would then assign a score to the message. This might be called a “spam score” or a “threat score,” and would be based on both the filtering criteria of the system (e.g., virus detection programs, spam detection programs, blacklists, whitelists, greylists, message traffic analyzed by a message management system, etc.) and the user preferences established by the intended recipient of the message. Accordingly, if the threat score assigned to an incoming message passes a predetermined threshold (e.g., exceed or fall below a threshold, depending on the implemented scale), the attributes of that message have led to the determination that the message should be sent to the permanent quarantine because, according to the current settings and criteria, it is harmful to, or otherwise unwanted by, the user/user's system.

The above-described process for filtering “bad” messages 135 relates to the filtering of messages 135 which have affirmatively been found to be malicious, spam, etc. However, a “zero-hour threat” pertains to the those messages which are not positively identifiable (according to a given set of filtering criteria and settings) as harmful or otherwise unwanted by the user when first scanned/examined by the system 100. Since such messages are not positively determined to be a threat upon first inspection, perhaps because a specific virus definition has not yet been created, their immediate sending to the permanent quarantine 145 may be unwarranted. In addition, if the message is later determined to be “good” (e.g., a false positive), the delay in having the message reach the intended recipient once it has been cleared may be costly or generally annoying to the user. Accordingly, the disclosed principles provide a novel technique for handling those message that are not immediately identifiable as needing filtering, but that may nonetheless pose enough potential risk that further evaluation of the message before simply passing it on to the user is warranted.

As with the filtering of messages into the permanent quarantine 145, filtering of “zero-hour threat message” may be done using the graduated scale with a second threshold. As discussed above, the filtering system 100 examines an incoming message based on attributes indicative of its desirability or undesirability to an intended recipient of the electronic message, and would assign a threat score to the message. As discussed above, if the threat score of a message passes a the first threshold, the message would be sent to the permanent quarantine 145. However, if the threat score for the message did not pass that first threshold, but still passed a second threshold, then, according to the current settings and criteria, the attributes of that message have led to the determination that the message still might pose a threat or is harmful to, or otherwise unwanted by, the user/user's system. In such a case, the message would then be sent to a “temporary” or “zero-hour quarantine” 165 (or “penalty box”). Of course, if the attribute(s) of a message do not lead to a threat score that exceeds either the first or second thresholds, then the system 100 has determined that the message does not likely pose a threat/is unwanted, and may therefore be delivered to the intended recipient.

As used herein, the term “temporary quarantine” means that messages deemed to be a potential threat or potentially unwanted are sent there and held on a temporary basis so that they may be rescanned or otherwise reexamined by the system. The reexamination, which is discussed in greater detail below, is done to determine if a message can be positively determined to be a threat to or is unwanted by the intended recipient. For example, while a message sits in the temporary quarantine 165 and it was placed there because its attachment could be a malicious attachment, the filtering modules may have been updated with new virus definitions that positively identify that attachment as malicious. In the scaled exemplary system discussed above, an original threat score assigned to the message may not have passed the first threshold, but did pass the second threshold. Thus, the message's attributes were such that some potential threat was detected. Upon reexamination, the updated virus definition may now identify the attachment as a now-known virus, and thus the threat score of the message would be revised to reflect this determination. If the revised threat score now passes the first threshold, the message can be positively identified as malicious, and sent to the permanent quarantine 145 instead.

In one example of zero-hour threat prevention in accordance with the disclosed principles, the system 100 may be configured to quarantine any attachment in a message that is an executable file, an executable within another document, or an executable within an archives Thus, as represented by Block 240 in the diagram of FIG. 2, a message 165 having one or more attributes that lead to the determination that the message poses a potential threat to, or is unwanted by, the user, although not determined to positively pose a threat, is sent to the zero-hour quarantine 165. In one embodiment, binary scanning combined with, for example, traditional file name scanning may be used to make that determination. Since most business transactions do not contain executable file attachments, either alone or embedded in another file, this approach provides a good first step toward zero-hour detection of messages.

In order to catch all executables in incoming messages 120, the disclosed zero-hour process may scan attachments in binary scan mode. This could be extended to open up other non-executable documents and archives. In addition, the system may also trap any files that are found in a named list (e.g., MIME type style or extension name) of executables. For example, it is not likely that someone would rename a harmless document to be an executable; it is more likely that someone would rename a harmful executable to something else. The combination of filtering, shown collectively in FIG. 1B as being a collection of filtering modules 170, 172, 174, 176, 185 within the cluster of intermediate pre-processors 105, will allow the system to trap new executable types that are not yet recognized by a scanning engine, but that are on a predetermined list of named executables. Moreover, such named executables can be kept in a table/file so that others can be added easily. The combination of filtering modules 170, 172, 174, 176, 185 illustrated in FIG. 1B may correspond to one or more of the email pre-processors 115 shown in FIG. 1A. Of course, other types of filtering modules may also be included, and the examples illustrated and discussed herein are not exclusive.

Also, because the disclosed zero-hour threat detection technique may be implemented with an e-mail management system, such as the one mentioned above, the type of attributes of incoming messages that are examined can be expanded, while still based on specific information obtained from the incoming message in question. More specifically, while an attachment or the identified source IP address sending the incoming message may be enough to classify the message as a potential or zero-hour threat, data detected from the message may also be used by such a management system to more accurately assess the potential threat of the message. As a result, even if the incoming message alone does not include an attribute sufficient to trigger the zero-hour threat process, attributes of the message can be used with the broader information provided by the management system. Accordingly, examples of attributes of an incoming message that may be examined by the zero-hour threat system for potential threats include:
an attachment to the incoming message
a count of the number of intended recipients of the incoming message
a virus in the incoming message
a worm in the incoming message
   But with a message management system, the attributes can also be expanded to include:
a count of the number of sources sending a message substantially similar to the incoming message
count of connection attempts from a source IP address sending the incoming message
count of current open connections from a source IP address sending the incoming message
duration of connection from a source IP address sending the incoming message
count of messages from a source IP address sending the incoming message
size of the incoming message
count of spam messages from a source IP address sending the incoming message
count of virus infected messages from a source IP address sending the incoming message
count of messages from a source IP address sending the incoming message having a previous unwanted binary attachment
count of messages from a source IP address sending the incoming message previously determined to have unwanted content
count of messages from a source IP address sending the incoming message which were previously blocked, black-holed, spooled, or quarantined

Based on the above, in one exemplary configuration of the system 100, zero-hour threat scanning (e.g., advanced heuristics, primitive file typing) would simply be one of the scans in a chain of scans normally done by the intermediate preprocessing service 105 on incoming messages 120. In many embodiments, ‘attachment manager’ scanning 172, anti-virus heuristics 170, filtering based on the network-wide issue detector 174, the manual failsafe override 176, and scan by an anti-spam engine 185 could be used in combination or separately to scan for zero-hour threats. If an ‘attachment manager’ 172 has been enabled for a customer, its file-typing output could be saved and used for zero-hour scanning to optimize processing time. In many embodiments, the zero-hour signature scanning can be made more efficient than anti-virus scanning if it is conducted in front of the anti-virus scans. Detected zero-hour suspect e-mails 160 will go into a quarantine that is separate from “spam” and “virus” quarantine discussed above, and instead will go into the zero-hour quarantine 165 introduced above. In addition, such separate zero-hour quarantine 165 may be illustrated as a separate tab in a graphical user interface (not illustrated) to allow marketing of such zero-hour protection capabilities to users of the overall filtering system 100.

In other embodiments, distinct quarantines for each type of detected unwanted message may be established. For example, if there is a hit with the attachment manager 172 or an anti-spam engine 185, the e-mail could be sent to a ‘spam quarantine.’ If there is a hit with anti-virus scans or the zero-hour signature table, the e-mail could be sent to a ‘virus quarantine.’ If there is a hit with anti-virus heuristics 170, primitive file typing, or a zero-hour anti-virus engine, the e-mail could be sent to the zero-hour quarantine. For these zero-hour messages 160, signatures or hashes of the attachments may be created as they are passed into the zero-hour quarantine 165. To optimize creation of the hash, the zero-hour threat system can be configured to only create a hash on the first ‘n’ and/or last ‘n’ bytes of any attachment. The system can create a job that runs periodically and scans all hashes and “forwards” any attachment with multiple hits to, for example, the service provider's anti-virus ‘administrative quarantine.’ Alternatively, the system can simply forward all zero-hour messages 160 into the anti-virus administrative quarantine.

In addition, customer administrators can forward zero-hour messages 160 to the anti-virus administrator. In fact, in such embodiments, multiple hits on suspect messages may overlap with previously submitted messages. The anti-virus administrator could submit these messages as potential misses to anti-virus vendors. As the anti-virus administrator identifies zero-hour misses, the system could flag the misses and have their signatures deposited into the zero-hour signature table mentioned above. The anti-virus administrator would be able to mark any message deemed a zero-hour miss. Over time, the signatures will be promoted to anti-virus definition files, and thus may be retired from the zero-hour signature table. In such embodiments, if a zero-hour signature has already been retired from the signature table and an anti-virus administrator tries to add it back, a warning message could pop up. In related embodiments, the anti-virus administrator would still be able to override this warning, in case system resources are under attack and it is desirable to save system resources by placing a block before the anti-virus scan engines kick in. This could be implemented on future incoming messages using the manual failsafe override 176.

In addition, the filtering modules 170, 172, 174, 176, 185 may include a network-wide issue detector 174 for even further filtering of incoming messages 120. This detector 174 could be configured to detect if a substantially similar attachment is being transmitted from a large number of sources. For example, if the same file type, with the same or substantially similar file name or size has been detected as originating from a number of (typically unrelated) source IP addresses, then such an attachment could be deemed harmful or otherwise unwanted. This is because it is unlikely that a number various sources would be sending out the same attachment to various destinations, unless that attachment is a mass-mailing or other type of spam, or is being involuntarily mailed from these multiple sources (e.g., a replicating virus). In any of these situations, the detector 174 can be configured to filter such attachments (or perhaps the entire messages) as potentially harmful or unwanted.

An automated quarantine summary notification message 155 (if enabled) may be sent out immediately or perhaps at the nearest hour whenever any attachment goes into the penalty box quarantine 165. This is the case since it might be deemed important that customers be aware of the fact that they have a suspect e-mail 160 that has been trapped. Sending such a notification message is illustrated as Block 245 in the diagram in FIG. 2. If advanced zero-hour heuristics are not in place to make that determination, it would be beneficial for the system 100 to let the customer know immediately to balance out any false positives. Waiting for the once-per-day notification may not be sufficient. As applications migrate toward advanced zero-hour heuristics, the need for the immediacy of such a notification may be obsolete (i.e., later phases of development and implementation of the zero-hour system). For all three quarantine types (spam, virus, and zero-hour), if configured as discussed above, the usual notification message 155 could be sent out if a new message or messages have been put into the quarantines. In addition, an hourly message could be sent out for any new messages that have been deposited into the zero-hour quarantine 165, rather than the sending of an immediate notification.

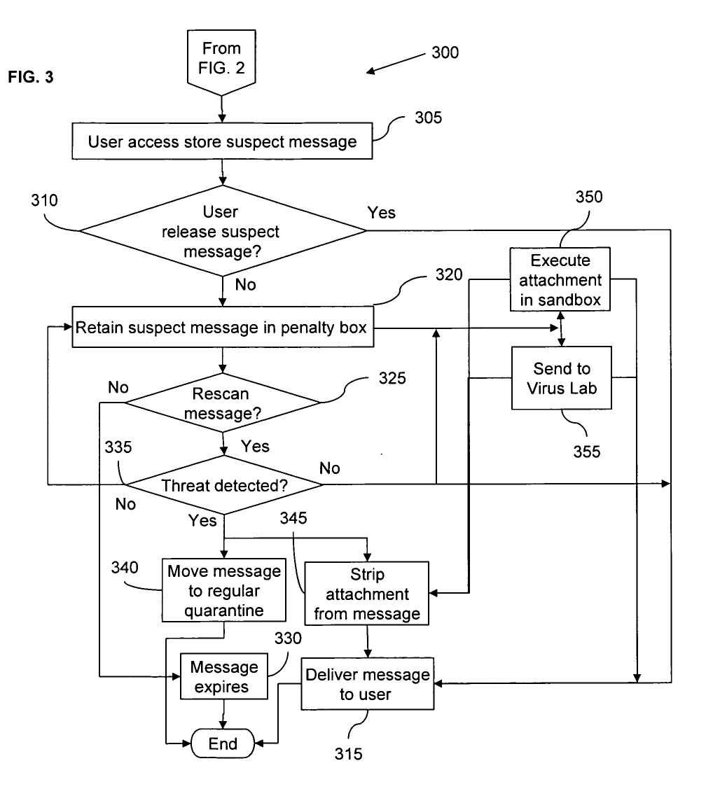

FIG. 3 illustrates a process flow 300 for handling of messages 160 already suspected of containing zero-hour threats, and thus are currently stored in the zero-hour quarantine 165. Accordingly, the flow diagram 300 in FIG. 3 can be seen as continuing from the diagram in FIG. 2. Looking specifically at FIG. 3 in conjunction with FIG. 1A and FIG. 1B, a user can access the zero-hour suspect messages 160 stored in the penalty box 165, typically via the message center website 150. This is illustrated as Block 305 in FIG. 3. The user could have the ability to immediately release a quarantined message 160. This could be done through, for example, clicking-through an automated quarantine summary notifications 155 or directly accessing the quarantine site 165 itself if they know that the message 160 is legitimate. This user-based release of zero-hour suspect messages is represented in Decision Block 310 in FIG. 3. The level of user interaction may be governed by the administrator. If the user releases the message 160, the message 160 may then be delivered to the user, which is illustrated by the process passing to Block 315 in FIG. 3.

If the user does not release the suspect message 160, the process passed to Block 320, and the system can retain any unreleased messages 160 in the zero-hour quarantine 165 for a user-specified period of time. The zero-hour system may then re-scan (Block 195 in diagram of FIG. 2) the stored, unreleased messages 160 for viruses or other harmful program after a predetermined period of time has passed. For example, updated virus, etc. definitions may have been obtained since the message 160 was last scanned. Whether a quarantined message 160 is rescanned is represented in Decision Block 325 of FIG. 3.

If the message 160 is not re-scanned, it may remain in the zero-hour quarantine 165 until it expires. Message expiration is illustrated in Block 330. If the message 160 does expire, the process for that message 160 would end after that. Message expiration time may again be established by the user, or it may be established by an administrator. These messages 160 are effectively dead and will typically go away upon quarantine expiration. Any dead messages in a quarantine will not typically be subsequently re-scanned 195, but could be if desired. In addition, dead messages could still be able to be forwarded until they roll out of the quarantine, if desired.

At Decision Block 325, if the attachment is re-scanned 195, the process for that message 160 moves to Decision Block 335, where it is determined whether a definite threat is now detected. For example, since the message 160 was held in the zero-hour quarantine 165, a virus definition or some other update may have occurred and the “potential” threat in the message 160 may now be verified as a definite threat based on the updated definitions, spam filters, etc. Such a re-scan 195 may occur for the first time after “n” hours in the penalty box 165. Then, the system could be configured to re-scan every hour, for example. If a threat is detected, the process would move to Block 340 in FIG. 3, where the message 160 may be passed to the regular quarantine 145. Alternatively, the message 160 may still be forwarded to the user (or an administrator or other location) if a definite threat is detected, but the suspect attachment would first be stripped from the message. This process is illustrated in Block 345 of FIG. 3.

In addition, if the re-scanning 195 of the message 160 in the penalty box has not verified a threat and the message 160 is not set for expiration, the re-scanning 195 could be set to continue for those messages 160 that haven't passed the holding period. In re-scan mode, in one embodiment, the system may be configured so that only anti-virus scans take place. When an anti-virus hit is registered, the signature for the zero-hour message can be removed (marked inactive) from the zero-hour signature table since this particular signature or definition is now verified. Alternatively, the system can re-scan 195 against the zero-hour signature table and move failing messages to the virus quarantine 145 upon a hit. The system could be configured to periodically re-scan 195 with both the zero-hour signature and the anti-virus scan engines in order to retire signatures, as well. The signatures may simply be kept in the table to save processing time. If no threat is detected upon re-scanning 195, the message 160 could simply be subject to the user-specified disposition, in accordance with the discussion set forth above and represented by Block 315 of FIG. 3. Or the message may simply be retained in the penalty box, as shown in Block 320, under one of the other scenarios (or indefinitely, if desired) discussed above.

In yet another embodiment, if a possible zero-hour threat is detected in a message 160, the message 160 (or more likely, the suspect attachment) may be passed to a “sandbox” 190. This optional process is illustrated by Block 350 in FIG. 3. Alternatively, the message 160 (again, more likely the suspect attachment) may be passed to a “Virus Lab” for testing This optional process is illustrated by Block 355 in FIG. 3. Alternatively, the message 160 may be passed directly from the penalty box to the sandbox 190 or the Virus Lab for testing without a re-scan, as illustrated in the diagram of FIG. 3.

In a Virus Lab, the technicians there can evaluate the attachment, as needed. In the sandbox 190, the suspect executable program is actually executed to see what the program does, such that proper classification of the file(s) may be made. The “behavior” of the program upon execution is monitored to determine if it demonstrates threatening characteristics, such as those typically seen by viruses, worms, or other harmful programs. For example, if the program begins to replicate itself, tries to manipulate registry settings, or tries to send itself to other locations, these characteristics are most often associated with the behavior of a harmful program, and thus the file is likely a harmful file. If the sandbox 190 execution reveals that the attachment is likely a harmful program, then the attachment may be stripped from the message, as illustrated in Block 345 of FIG. 3, and the message 130 delivered to the user. However, if the sandbox 190 execution shows the attachments is not harmful, then the message 130 and attachment may simply be delivered to the user, as shown by Block 315 of FIG. 2. Alternatively, the message 160 may be retained in the penalty box 165, and can be forwarded to a virus laboratory for further analysis.

One benefit of configuring the disclosed zero-hour threat detection process with a sandbox 190 or other attachment analysis process is that the service provider of the detection process may submit such attachments to anti-virus companies for further analysis. In addition, if analysis in the sandbox 190 determines that the attachment is indeed harmful, the service provider could flag it as such in the zero-hour signature table or in its regular virus definitions, etc. If written to a zero-hour signature table, it could then be used as a stop-gap for further incoming messages being filtered, until proper definition files are released by the anti-virus vendors, as discussed above.

Since the system provides the ability to re-scan zero-hour suspect messages 160 multiple times, as well as allow users to choose a possible disposition of the message 160, the number of false positives seen by conventional zero-hour systems will be reduced or eliminated altogether. The trade-off between delayed delivery of messages vs. potential virus-laden messages being delivered in a timely manner is something that each customer will have to consider and adjust when enabling this feature. Since the system offers re-scanning and it may be set as automatic along with disposition management, there should be no issues that can occur when an attachment manager is used for this same purpose. Over time, the customer will adjust the maximum hold periods to fit their business or personal needs.

The disclosed zero-hour system will also have the ability to manually scan the zero-hour quarantined messages 160, publish early filtering (prior to anti-virus vendor definitions) upon virus acknowledgement, and provide that filtering for all customers (not just zero-hour enabled ones). Depending on how the zero-hour quarantine has been set up for specific implementations, either the end users or the system administrators may be managing their quarantines. When a user logs on to the web server 150, a web page is displayed that includes a link for displaying a summary of quarantined messages and/or attachments, including both regular quarantined messages and zero-hour quarantined messages. By clicking on a selected item, the user may be able to view the item and, depending on the attachment type, may be able to view the attachment. If the user so chooses, the user may be allowed to download an item suspected to contain a harmful program after the user has been given appropriate warning.

In view of the above features, a zero-hour quarantine system could be configured such that administrators could have the ability to do one or more of the following:
Turn on or off zero-hour on a per customer basis.
Turn on or off automated quarantine summary notification or quarantine visibility to end users.
Turn on or off manual deliver capability to the users. This would apply to both automated quarantine summary notifications and to the quarantine itself.
Set the maximum hold period per message.
Set up disposition (deliver upon scan period expiration, leave in quarantine upon scan period expiration, forward to virus quarantine upon positive virus scan, strip and deliver upon positive virus scan).
   When the zero-hour feature is activated by an administrator, an acknowledgment window could be displayed that describes what may be happening to messages 160 that land in the zero-hour quarantine 165. The system could positively track acknowledgment of the message 160. In some embodiments, the system may be configured to store a hash or version number of the legal text at the time since it will likely change over time.

While various embodiments of the disclosed principles have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 C.F.R. 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A method of filtering electronic messages from a network comprising a sending server and a destination server, the method comprising:
receiving an incoming electronic message from the sending server;
examining the electronic message for attributes indicative of its desirability or undesirability to an intended recipient of the electronic message;
assigning a threat score to the electronic message based on the examination;
sending the message to a permanent quarantine if the revised threat score passes the first threshold, sending the message to a temporary quarantine if the assigned threat score does not pass the second threshold but passes the second threshold, or delivering the message to an intended recipient if the assigned threat score does not pass the first or second threshold;
periodically reexamining the message, if sent to the temporary quarantine, for attributes indicative of its desirability or undesirability to the intended recipient of the message, and revising the threat score based on the reexamination; and
sending the message to a permanent quarantine if the revised threat score passes the first threshold, keeping the message in the temporary quarantine if the revised threat score does not pass the second threshold but passes the first threshold, or delivering the message to the intended recipient if the revised threat score does not pass the first or second threshold.

2. A method according to claim 1, further comprising sending a notification message to the intended recipient when the incoming message is sent to the temporary quarantine.

3. A method according to claim 1, wherein if the message is sent to the temporary quarantine and the attributes comprise an attachment, the method further comprising stripping the attachment from the message and delivering the message to the intended recipient.

4. A method according to claim 1, wherein if the electronic message is sent to the temporary quarantine and the attributes comprise an attachment, sending the attachment to a virus laboratory for examination of the attachment.

5. A method according to claim 1, wherein if the electronic message is sent to the temporary quarantine and the attributes comprise an attachment, sending the attachment to a testing area for executing the attachment.

6. A method according to claim 1, wherein an attribute of the incoming message is an executable file, the method further comprising assigning a threat score to the message that will pass the second threshold such that the message will be sent to the temporary quarantine.

7. A method according to claim 1, wherein the attributes examined are selected from the group consisting of:
an attachment to the incoming message;
a count of the number of intended recipients of the incoming message;
a virus in the incoming message;
a worm in the incoming message;
a count of the number of sources sending a message substantially similar to the incoming message;
count of connection attempts from a source IP address sending the incoming message;
count of current open connections from a source IP address sending the incoming message;
duration of connection from a source IP address sending the incoming message;
count of messages from a source IP address sending the incoming message;
size of the incoming message;
count of spam messages from a source IP address sending the incoming message;
count of virus infected messages from a source IP address sending the incoming message;
count of messages from a source IP address sending the incoming message having a previous unwanted binary attachment;
count of messages from a source IP address sending the incoming message previously determined to have unwanted content; and
count of messages from a source IP address sending the incoming message which were previously blocked, black-holed, spooled, or quarantined.

8. A system for filtering electronic messages from a network comprising a sending server and a destination server, the system comprising:
a message handler configured to receive an incoming electronic message from the sending server;
a message filtering process in the message handler and configured to examine the electronic message for attributes indicative of its desirability or undesirability to an intended recipient of the electronic message, and assign a threat score to the electronic message based on the examination;
a message disposition process in the message handler and configured to compare the assigned threat score to first and second thresholds, and then to send the message to a permanent quarantine if the assigned threat score passes the first threshold, send the message to a temporary quarantine if the assigned threat score does not pass the second threshold but passes the second threshold, or send the message to an intended recipient if the assigned threat score does not pass the first or second threshold;
wherein the message filtering process is further configured to periodically reexamine the message, if sent to the temporary quarantine, for attributes indicative of its desirability or undesirability to the intended recipient of the message, and revise the threat score based on the reexamination; and
wherein the message disposition process is further configured to send the message to a permanent quarantine if the revised threat score passes the first threshold, send the message to a temporary quarantine if the revised threat score does not pass the second threshold but passes the second threshold, or send the message to an intended recipient if the revised threat score does not pass the first or second threshold.

9. A system according to claim 8, wherein the message handler is further configured to send a notification message to the intended recipient when the incoming message is sent to the temporary quarantine.

10. A system according to claim 8, wherein if the disposition process sends the electronic message to the temporary quarantine and the attributes comprise an attachment, the disposition process is further configured to strip the attachment from the message and deliver the message to the intended recipient.

11. A system according to claim 8, further comprising a network portal associated with the message handler and accessible by a user via a computer network, the network portal configured to display to the user information representing at least a portion of an electronic message sent to the temporary quarantine.

12. A system according to claim 11, wherein the portal further provides the user the ability to cause disposition process to deliver a message sent to the temporary quarantine to the intended recipient.

13. A system according to claim 8, wherein an attribute of the incoming message is an executable file, the filtering process further configured to assign a threat score to the message that will pass the second threshold such that the disposition process will send the message to the temporary quarantine.

14. A system according to claim 8, wherein the attributes examined are selected from the group consisting of:
an attachment to the incoming message;
a count of the number of intended recipients of the incoming message;
a virus in the incoming message;
a worm in the incoming message;
a count of the number of sources sending a message substantially similar to the incoming message;
count of connection attempts from a source IP address sending the incoming message;
count of current open connections from a source IP address sending the incoming message;
duration of connection from a source IP address sending the incoming message;
count of messages from a source IP address sending the incoming message;
size of the incoming message;
count of spam messages from a source IP address sending the incoming message;
count of virus infected messages from a source IP address sending the incoming message;
count of messages from a source IP address sending the incoming message having a previous unwanted binary attachment;
count of messages from a source IP address sending the incoming message previously determined to have unwanted content; and
count of messages from a source IP address sending the incoming message which were previously blocked, black-holed, spooled, or quarantined.

15. A method of filtering electronic messages from a network comprising a sending server and a destination server, the method comprising:
receiving an incoming electronic message containing an attachment from the sending server;
examining the attachment for attributes indicative of its harmfulness to an intended recipient of the electronic message;
assigning a threat score to the electronic message or the attachment based on the examination;
sending the message and attachment to a permanent quarantine if the revised threat score passes the first threshold, to a temporary quarantine if the assigned threat score does not pass the second threshold but passes the second threshold, or to an intended recipient if the assigned threat score does not pass the first or second threshold;
periodically reexamining the attachment, if sent to the temporary quarantine, for attributes indicative of its harmfulness to the intended recipient of the message, and revising the threat score based on the reexamination; and
sending the message and attachment to a permanent quarantine if the revised threat score passes the first threshold, keeping the message and attachment in the temporary quarantine if the revised threat score does not pass the second threshold but passes the first threshold, or delivering the message and attachment to the intended recipient if the revised threat score does not pass the first or second threshold.

16. A method according to claim 15, further comprising sending a notification message to the intended recipient when the incoming message and attachment are sent to the temporary quarantine.

17. A method according to claim 15, wherein if the electronic message and attachment are sent to the temporary quarantine, sending the attachment to a virus laboratory for examination of the attachment.

18. A method according to claim 15, wherein if the electronic message and attachment are sent to the temporary quarantine, sending the attachment to a testing area for executing the attachment.

19. A method according to claim 15, wherein if the electronic message and attachment are sent to the temporary quarantine, stripping the attachment from the message and delivering the message to the intended recipient.

20. A method according to claim 15, wherein the examining is selected from the group consisting of:
binary scanning,
filename scanning, or
extension name scanning.

21. A method according to claim 15, wherein the attachment is an executable file, the method further comprising assigning a threat score that will pass the second threshold such that the message and attachment are sent to the temporary quarantine.

22. A method according to claim 15, wherein attributes examined to determine the harmfulness of the attachment are selected from the group consisting of:
a count of the number of intended recipients of the incoming message;
a virus in the attachment;
a worm in the attachment;
a count of the number of sources sending a message and attachment substantially similar to the incoming message and attachment;
count of connection attempts from a source IP address sending the incoming message;
count of current open connections from a source IP address sending the incoming message;
duration of connection from a source IP address sending the incoming message;
count of messages from a source IP address sending the incoming message;
size of the incoming message or attachment;
count of spam messages from a source IP address sending the incoming message;
count of virus infected messages from a source IP address sending the incoming message;
count of messages from a source IP address sending the incoming message having a previous unwanted binary attachment;
count of messages from a source IP address sending the incoming message previously determined to have unwanted content; and
count of messages from a source IP address sending the incoming message which were previously blocked, black-holed, spooled, or quarantined.

23. A system for filtering electronic messages from a network comprising a sending server and a destination server, the system comprising:
a message handler configured to receive an incoming electronic message containing an attachment from the sending server;
a message filtering process in the message handler and configured to examine the attachment for attributes indicative of its harmfulness to an intended recipient of the electronic message, and assign a threat score to the electronic message or the attachment based on the examination;
a message disposition process in the message handler and configured to compare the assigned threat score to first and second thresholds, and then to send the message and attachment to a permanent quarantine if the assigned threat score passes the first threshold, to a temporary quarantine if the assigned threat score does not pass the second threshold but passes the second threshold, or to an intended recipient if the assigned threat score does not pass the first or second threshold;
wherein the message filtering process is further configured to periodically reexamine the attachment, if sent to the temporary quarantine, for attributes indicative of its harmfulness to the intended recipient of the message, and revise the threat score based on the reexamination; and
wherein the message disposition process is further configured to send the message and attachment to a permanent quarantine if the revised threat score passes the first threshold, to a temporary quarantine if the revised threat score does not pass the second threshold but passes the second threshold, or to an intended recipient if the revised threat score does not pass the first or second threshold.

24. A system according to claim 23, wherein the message handler is further configured to send a notification message to the intended recipient when the incoming message is sent to the temporary quarantine.

25. A system according to claim 23, further comprising a network portal associated with the message handler and accessible by a user via a computer network, the network portal configured to display to the user information representing at least a portion of an electronic message sent to the temporary quarantine.

26. A system according to claim 25, wherein the portal further provides the user the ability to cause disposition process to deliver a message and attachment sent to the temporary quarantine to the intended recipient.

27. A system according to claim 23, wherein the disposition process is further configured to strip the attachment from the message and deliver the message to the intended recipient if the message and attachment are sent to the temporary quarantine.

28. A system according to claim 23, wherein the filtering process examines the incoming message using at least one selected from the group consisting of:
binary scanning,
filename scanning, or
extension name scanning.

29. A system according to claim 23, wherein the attachment is an executable file, the filtering process further configured to assign a threat score that will pass the second threshold such that the disposition process will send the message and attachment to the temporary quarantine.

30. A system according to claim 23, wherein attributes examined to determine the harmfulness of the attachment are selected from the group consisting of:
a count of the number of intended recipients of the incoming message;
a virus in the attachment;
a worm in the attachment;
a count of the number of sources sending a message and attachment substantially similar to the incoming message and attachment;
count of connection attempts from a source IP address sending the incoming message;
count of current open connections from a source IP address sending the incoming message;
duration of connection from a source IP address sending the incoming message;
count of messages from a source IP address sending the incoming message;
size of the incoming message or attachment;
count of spam messages from a source IP address sending the incoming message;
count of virus infected messages from a source IP address sending the incoming message;
count of messages from a source IP address sending the incoming message having a previous unwanted binary attachment;
count of messages from a source IP address sending the incoming message previously determined to have unwanted content; and
count of messages from a source IP address sending the incoming message which were previously blocked, black-holed, spooled, or quarantined.
